(19) United States
(12) Patent Application Publication
(10) Pub. No.: US 2013/0105446 A1
(43) Pub. Date: May 2, 2013

(54) Hybrid Arc/Laser-Welding Method For Aluminized Steel Part Using A Gas Including Nitrogen And/Or Oxygen

(71) Applicants: Francis Briand, Houston, TX (US); Olivier Dubet, Houston, TX (US)

(72) Inventors: Francis Briand, Houston, TX (US); Olivier Dubet, Houston, TX (US)

(21) Appl. No.: 13/809,552

(22) PCT Filed: May 5, 2011
(86) PCT No.: PCT/FR2011/051015

§ 371 Date: Jan. 10, 2013

(30) Foreign Application Priority Data
Jul. 13, 2010 (FR) 1055691

(51) Int. Cl. B23K 9/16

(52) U.S. Cl. CPC B23K 9/16
USPC 219/74

(57) ABSTRACT

The invention relates to a hybrid laser/arc-welding method using an electric arc and a laser beam that are combined together within a single welding bath, to which molten metal is supplied by melting a filler wire, wherein the welding bath is provided on at least one steel part including an aluminum surface coating, and a protective gas is used, characterized in that the protective gas consists of at least one main compound selected from argon and helium, and of at least one additional compound selected from nitrogen and oxygen.

The invention relates to a process for the laser/arc hybrid welding of steel parts comprising a surface coating based on aluminum, in particular a coating of aluminum and silicon, using a shielding gas formed of argon and/or helium to which small proportions of nitrogen or oxygen are added.

Certain steels, referred to as aluminized steels since they are coated with aluminum or with an alloy based on aluminum, such as USIBOR™ steels, have very high mechanical characteristics after hot-drawing and are, therefore, increasingly used in the field of the construction of motor vehicles, when a weight saving is desired.

Indeed, these steels are designed to be thermally treated then quenched during the hot-drawing operation and the mechanical characteristics which result therefrom enable a very significant lightening of the weight of the vehicle compared to a standard high yield strength steel. They are mainly used for manufacturing bumper beams, door reinforcements, center pillars, window pillars, etc.

Document EP-A-1878531 proposes to weld aluminized steels of this type by use of a laser/arc hybrid welding process. The laser/arc hybrid welding principle is well known in the prior art.

However, it has been observed in practice that after an operation for the hybrid welding, with a shielding atmosphere formed of an He/Ar mixture, of steel parts coated with aluminum or with an aluminum alloy, in particular an alloy of Al/Si type, and post-welding heat treatment comprising hot-drawing at 920° C. then a quenching in the tool (30° C./s), a phase with lower tensile strength than the base metal and than the weld metal zone often appeared in the welded joint.

However, this phase with lower tensile strength constitutes a brittle zone of the weld thus obtained, as explained below. These more brittle zones appear within the martensite zone in the form of islands of white phase containing aggregates of aluminum originating from the surface layer.

After analysis, it was determined that this phase contains a significant percentage of aluminum (>2%) which gives rise to no austenitic transformation of the steel during the heat treatment thereof before drawing, that is to say that this phase remains in the form of delta ferrite and the result thereof is a lower hardness than the rest of the part that has undergone a martensitic/bainitic transformation.

However, the phase not transformed into martensite phase may result, during a mechanical characterization of the joint after welding, and drawing followed by heat treatment, in cracks, or even in a rupture by shearing of the welded joint, since these zones that have incorporated aluminum have a lower resistance of the weld than that of the deposited metal.

The problem that is faced is hence to propose an arc/laser hybrid welding process that improves the mechanical properties of the welded joint, during an operation for welding steel parts coated with a layer comprising aluminum. More specifically, the problem is to be able to obtain a homogeneous microstructure of martensite type in the weld metal zone, that is to say in the weld joint, after hot-drawing, typically at around 920° C., and quenching in the drawing tool, typically with a cooling rate between 800° C. and 500° C. of the order of 30° C./s.

The solution of the invention is a laser/arc hybrid welding process using an electric arc and a laser beam that are combined together, in particular within a single weld pool, wherein the weld metal is provided by melting a consumable wire and the weld pool is produced on at least one steel part comprising an aluminum-based surface coating, and wherein use is furthermore made of a shielding gas, characterized in that the shielding gas consists of at least one main compound chosen from argon and helium, and of at least one additional compound chosen from nitrogen and oxygen.

According to the invention, the weld pool, and therefore subsequently the welding joint, is therefore obtained, at the joint plane formed by the bringing into contact, in particular end to end, of the parts to be welded, by melting the constituent steel of the parts under the simultaneous action of a laser beam and of an electric arc which combine with one another to melt the metal of the part or parts to be welded, while an additional provision of weld metal is obtained furthermore by virtue of a consumable wire which is also melted, preferably by the electric arc, the weld metal thus obtained being deposited in the weld pool formed on the part or parts to be assembled.

In order to solve the aforementioned problem, according to the invention, use is made, as a shielding atmosphere of the welding zone, in particular of the weld pool, of a gas mixture which is formed solely, on the one hand, of argon, helium or the two as main compound(s) of the gas mixture and, on the other hand, of nitrogen or oxygen, or even of the two, as additional compound(s), so as to constitute a binary gas mixture of Ar/N₂, Ar/O₂, He/O₂ or He/N₂ type, or a ternary gas mixture of Ar/He/N₂ or Ar/He/O₂ type, or even a quaternary gas mixture of Ar/He/O₂/N₂ type. In all the cases, the proportion of main compound (i.e. Ar or He) or the sum of the proportions of the main compounds (i.e. Ar and He) is greater than the proportion of additional compound (i.e. N₂ or O₂) or the sum of the proportions of the additional compounds (i.e. N₂ and O₂) present in the gas mixture.

Among these various gas mixtures that can be used, two gas mixtures are particularly preferred as they lead to very good results, as explained below, namely the Ar/N₂ or Ar/He/N₂ mixtures containing at most 10% of nitrogen (% by volume) and advantageously from 3% to 7% approximately of nitrogen. Generally, it should be noted that within the context of the present invention, unless otherwise indicated, all the percentages (%) given are percentages by volume (% by volume).

Indeed, the implementation of an arc/laser hybrid welding process using a shielding gas mixture formed of argon and/of of helium, on the one hand, and of nitrogen and/or oxygen, on the other hand, makes it possible to obtain, during the assembling of aluminized steel parts, a weld joint of martensitic microstructure free or virtually free of whitish ferrite islands, since the addition of O₂ or of N₂ makes it possible to trap the aluminum originating from the surface layer and which is released during the melting of said layer under the effect of the arc and of the laser beam.

The trapping of the aluminum by the O₂ or N₂ compounds leads to the formation of compounds of Al₂O₃ or AlN type thus avoiding the formation of ferrite or of other harmful intermetallic compounds. In fact, the aluminum oxides or nitrides thus formed float at the surface of the pool, thus preventing the dissolution of the aluminum in the weld pool.

The result of this is a suppression or at least a sizable reduction of the incorporation of aluminum into the weld, therefore an improvement of the tensile strength due to a total or virtually total disappearance of the whitish delta ferrite phase customarily observed.

Depending on the case, the process of the invention may comprise one or more of the following characteristics:
the shielding gas contains from 1% to 20% by volume of said at least one additional compound.
the shielding gas contains from 1% to 15% by volume of said at least one additional compound.
the shielding gas contains at least 2% by volume of said at least one additional compound.
the shielding gas contains at most 10% by volume of said at least one additional compound.
the shielding gas contains only nitrogen as additional compound.
the shielding gas contains at least 4% by volume of nitrogen as additional compound.
the shielding gas contains at least 5% by volume of nitrogen as additional compound.
the shielding gas contains at most 8% by volume of nitrogen as additional compound.
the shielding gas contains at most 7% by volume of nitrogen as additional compound.
the shielding gas contains at least 5.5% by volume of nitrogen and at most 6.5% by volume of nitrogen.
the shielding gas is a He/Ar/N₂ or Ar/N₂ mixture.
the steel part or parts comprise an aluminum-based surface coating having a thickness between 5 and 100 μm, preferably less than or equal to 50 μm. The coating covers at least one surface of the part or parts but preferably no or virtually no aluminum-based coating is present on the edges of ends of said part or parts, that is to say on the edges of a sheet for example.
the metal part or parts are made of steel with a surface coating based on aluminum and on silicon, preferably the surface coating contains more than 70% by weight of aluminum.
the metal part or parts are made of steel with a surface coating consisting essentially of aluminum and silicon (Al/Si).
the metal part or parts comprise a surface coating based on aluminum and silicon containing a proportion of aluminum between 5 and 100 times greater than that of silicon, for example a proportion of aluminum of 90% by weight and a proportion of silicon of 10% by weight, i.e. a surface coating layer comprising 9 times more aluminum than silicon.
the metal part or parts comprise a surface coating based on aluminum and silicon containing a proportion of aluminum between 5 and 50 times greater than that of silicon, especially a proportion of aluminum between 5 and 30 times greater than that of silicon, in particular a proportion of aluminum between 5 and 20 times greater than that of silicon.
several parts are welded with one another, typically two parts; it being possible for said parts to be identical or different, in particular in terms of shapes, thicknesses, etc.
the parts are made of highly alloyed steel (>5% by weight of alloy elements), weakly alloyed steel (<5% by weight of alloy elements) or unalloyed steel, for example a carbon steel.
the welding wire is a solid wire or a flux-cored wire.
the welding wire has a diameter between 0.5 and 5 mm, typically between around 0.8 and 2.5 mm.
the consumable wire is melted by the electric arc, preferably an arc obtained by means of a MIG welding torch.
the consumable wire contains carbon and/or manganese (min 0.1% C and min 2% Mn).
the part or parts to be welded are chosen from tailored blanks and pipes.
the part or parts to be welded are components of mufflers.
the parts are positioned and welded in a square butt configuration.
the electric arc is generated by a welding torch of MIG (Metal Inert Gas) type.
the laser beam is generated by a laser generator or device of CO₂, YAG, fiber, especially ytterbium or erbium fiber, or disk type.
the laser beam precedes the MIG arc during the welding, when considering the direction of the welding.
the MIG welding regime is of short-arc type.
the welding voltage is less than 20 V, typically between 11 and 16 V.
the welding intensity is less than 200 A, typically between 118 and 166 A.
the welding speed is less than 20 m/min, typically between 4 and 6 m/min.
the part or parts to be welded have a thickness between 0.8 and 2.5 mm, preferably between 1.8 and 2.3 mm. The thickness is considered at the joint plane to be produced, that is to say at the location where the metal is melted in order to form the welding joint, for example at the end edge of the part or parts to be welded.
the welding joint has a structure of martensitic type.
the pressure of the gas is between 2 and 15 bar, for example of the order of 4 bar.
the flow rate of the gas is between 10 and 40 l/min, typically of the order of 25 l/min.
the focal point of the laser beam is focused above the part to be welded, and in a range between 3 to 6 mm.
the distance between the filler wire and the laser beam must be between 2 and 3 mm.
several parts are welded with one another, typically two parts.
the gas mixture used within the context of the present invention may be produced either directly on site by mixing of the constituents of the mixture in the desired proportions using a gas mixer, or be in prepackaged form, that is to say produced in a packaging factory then subsequently transported to its place of use in suitable gas containers, such as welding gas cylinders.

The invention will now be better understood owing to the following description and examples carried out to show the effectiveness of the arc/laser hybrid welding process of the invention.

### EXAMPLES

The laser/arc hybrid welding process according to the invention gave good results during the implementation thereof for carrying out a hybrid welding, using a laser source of CO₂ type and a MIG arc welding torch, of steel parts coated with a layer of around 30 μm of an aluminum/silicon alloy in respective proportions of 90% and 10% by weight.

The welded parts have a thickness of 2.3 mm.

Within the context of the tests carried out, the gas used, which is dispensed at a flow rate of 25 l/min and at a pressure of 4 bar, is:
Test A (comparative): ARCAL 37 mixture formed of 70% helium and 30% argon,
Test B: ARCAL 37 mixture to which 6% N₂ is added.
Test C: ARCAL 37 mixture to which 3% O₂ is added.

The ARCAL 37 mixture is sold by Air Liquide.

The torch used is a MIG torch of reference OTC fed by a filler wire of Nic 535 type (0.7% C and 2% Mn) having a diameter of 1.2 mm, which is delivered at a rate of 3 m/min.

The welding voltage is 15 V approximately and the intensity is approximately 139 A, which are obtained by virtue of a generator of Digi@wave 500 type (short arc/short arc +) in synergic mode (EN 131) sold by Air Liquide Welding France.

The laser source is a CO₂ laser oscillator having a power of 12 kW.

The welding speed achieved is 4 m/min.

The parts to be welded are square butt-positioned tailored blanks made of aluminized steel (Al/Si) of Usibor 1500™ type.

The results obtained show that the presence of N₂ in an argon/helium mixture leads to much better results than the tests without nitrogen in the shielding gas.

Similarly, the presence of a small proportion of O₂ in an argon/helium mixture makes it possible to counter the effect of suppressing austenitic transformation caused by the presence of aluminum in the weld metal zone.

Indeed, by using the Ar and/or He and N₂ and/or O₂ mixtures according to the invention, a significant improvement in the results is therefore observed, which improvement increases proportionally to the content of N₂ or O₂ in the mixture. Indeed, the micrographs show that, in both cases, the white phases have completely disappeared, whereas that is not the case with the ARCAL 37 mixture alone.

Moreover, with the additions of O₂ or N₂, the resistance to rupture of the joint, after austenitization and quenching, is equivalent to that of the base metal.

The results obtained during the tests show that an addition of nitrogen to argon and/or helium makes it possible to greatly improve the quality of the welding of steels coated with a surface layer of aluminum/silicon alloy, in particular a homogeneous microstructure of martensite type in the weld metal zone.

The improvement is even more significant when the nitrogen content increases but with an optimum of less than 10% by volume, which would encourage the use of around 6% to 7% of nitrogen in argon or in argon/helium.

The improvement is also even more significant when the oxygen content increases, but with an optimum of less than 10% by volume, which would encourage the use of around 3% to 5% of nitrogen in argon or in argon/helium.

The process of the invention is particularly suitable for the welding of tailored blanks used in the field of motor vehicle construction, of components of mufflers, in particular for vehicles, and for the welding of pipes.

1-12. (canceled)

13. A laser/arc hybrid welding process using an electric arc and a laser beam that are combined with one another, a weld pool being produced on at least one steel part comprising an aluminum-based surface coating, wherein the weld metal is provided by melting a consumable wire, and wherein use is furthermore made of a shielding gas, wherein the shielding gas consists of at least one main compound chosen from argon and helium, and of at least one additional compound chosen from nitrogen and oxygen.

14. The process of claim 13, wherein the shielding gas contains from 1% to 20% by volume of said at least one additional compound.

15. The process of claim 13, wherein the shielding gas contains from 2% to 10% by volume of said at least one additional compound.

16. The process of claim 13, wherein the shielding gas contains only nitrogen as additional compound.

17. The process of claim 13, wherein the shielding gas contains from 4% to 7% by volume of nitrogen as additional compound.

18. The process of claim 13, wherein the shielding gas is a He/Ar/N2 or Ar/N2 mixture.

19. The process of claim 13, wherein the steel part or parts comprise an aluminum-based surface coating having a thickness between 5 and 100 μm.

20. The process of claim 13, wherein the metal part or parts are made of steel with a surface coating based on aluminum and on silicon.

21. The process of claim 13, wherein the consumable wire is melted by the electric arc.

22. The process of claim 13, wherein the consumable wire contains carbon and/or manganese (min 0.1% C and min 2% Mn).

23. The process of claim 13, wherein the part or parts to be welded are chosen from tailored blanks, pipes or components of mufflers.

24. The process of claim 13, wherein the parts are positioned and welded in a square butt configuration.
